(19) United States
(12) Patent Application Publication
(10) Pub. No.: US 2005/0118362 A1
(43) Pub. Date: Jun. 2, 2005

(54) Thermal transfer element with light-to-heat conversion layer having concentration gradient

(76) Inventors: Mu-Hyun Kim, Suwon-si (KR); Byung-Doo Chin, Suwon-si (KR); Tae-Min Kang, Suwon-si (KR); Seong-Taek Lee, Suwon-si (KR)

Correspondence Address: ROBERT E. BUSHNELL, 1522 K STREET NW, SUITE 300, WASHINGTON, DC, 20005-1202, US

(21) Appl. No.: 10/944,902

(22) Filed: Sep. 21, 2004

(30) Foreign Application Priority Data
Nov. 29, 2003 (KR) 2003-87791

(51) Int. Cl. B41M 5/40

(52) U.S. Cl. 428/32.81; 430/200

(57) ABSTRACT

A thermal transfer element that a radiation absorber contained in a light-to-heat conversion layer has a concentration gradient and laser-transfers an organic thin-film layer. The thermal transfer element includes a base substrate which is a support substrate; a light-to-heat conversion layer formed on the base substrate, converting incident light to heat energy and containing a radiation absorber; and a transfer layer for image formation, wherein the radiation absorber of the light-to-heat conversion layer has a concentration distribution that the concentration is lower as it is closer to the transfer layer. The radiation absorber of the light-to-heat conversion layer has a concentration distribution that the concentration is gradually or stepwise decreased as it is farther from the base substrate and as it is closer to the transfer layer.

### CLAIM OF PRIORITY

This application makes reference to, incorporates the same herein, and claims all benefits accruing under 35 U.S.C. § 119 from an application for THERMAL TRANSFER ELEMENT WITH LTHC HAVING GRADIENT CONCENTRATION earlier filed in the Korean Intellectual Property Office on Nov. 29, 2003 and there duly assigned Serial No. 2003-87791.

### BACKGROUND OF THE INVENTION

1. Field of the Invention

The present invention relates to a thermal transfer element and, more particularly, to a laser thermal transfer element capable of preventing a characteristic deterioration of an organic thin-film layer.

2. Description of the Related Art

In general, an organic electroluminescent display device includes an anode electrode which is a lower electrode formed on an insulating substrate, an organic thin-film layer formed on the anode electrode, and a cathode electrode which is an upper electrode formed on the organic thin-film layer. The organic thin-film layer includes at least one of a hole injecting layer, a hole transporting layer, an emission layer, a hole blocking layer, an electron transporting, and an electron injecting layer.

A method of forming the organic thin-film layer includes a deposition method and a lithography method. The deposition method is one which forms an organic emission layer by vacuum-depositing an organic light-emitting material using a shadow mask. The deposition method has disadvantages in that it is difficult to form fine patterns of fine pitch due to a transformation of a mask and it is difficult to be applied to a large-size display device. The lithography method is one which forms the organic emission layer by depositing an organic light-emitting material layer and then patterning the deposited organic light-emitting material layer using a photoresist. The lithography method can form the fine patterns of fine pitch but has a disadvantage in that characteristics of the organic emission layer are degraded by a developing solution used to form a photoresist pattern or an etching solution of the organic emission layer.

In order to resolve the above problems, an ink jet method has been suggested that patterns directly the organic emission layer. The ink jet method is one which dissolves or disperses a light-emitting material in a solvent and discharges liquid droplets containing the light-emitting material from a head of an ink jet printer to form an organic emission layer. The ink jet method is simple in process but has disadvantages in that a manufacturing yield is low, a film thickness is not uniform and also is difficult to be applied to a large-size display device.

Meanwhile, a method of forming an organic emission layer using a thermal transfer method which is a dry-etching method has been suggested. The thermal transfer method is one which converts light from a light source to thermal energy, and transfers an image forming material onto an insulting substrate by using the converted thermal energy to form R, G, and B organic emission layers.

### SUMMARY OF THE INVENTION

The present invention provides a thermal transfer element which has a light-to-heat conversion layer in which a concentration distribution is lower as it is closer to an organic emission layer and thus can prevent characteristic deterioration of an organic emission layer.

The present invention also provides a thermal transfer element suitable for an organic electroluminescent display device, which can prevent the characteristic deterioration of an emission layer.

In an exemplary embodiment of the present invention, a thermal transfer element includes: a base substrate which is a support substrate; a light-to-heat conversion layer formed on the base substrate, converting incident light to heat energy and containing a radiation absorber; and a transfer layer for image formation, wherein the radiation absorber of the light-to-heat conversion layer has a concentration distribution that a concentration is lower as it is closer to the transfer layer.

The radiation absorber of the light-to-heat conversion layer has a concentration distribution that the concentration is gradually lower as it is closer to the transfer layer.

The radiation absorber of the light-to-heat conversion layer has a concentration distribution that the concentration is stepwise lower as it is closer to the transfer layer.

The radiation absorber of the light-to-heat conversion layer has a concentration distribution that the concentration is stepwise lower as it is farther from the base substrate and as it is closer to the transfer layer.

The radiation absorber of the light-to-heat conversion layer has a concentration distribution that the concentration is gradually lower as it is farther from the base substrate and as it is closer to the transfer layer.

The radiation absorber of the light-to-heat conversion layer absorbs light generated from one of infrared laser, visible laser and ultraviolet laser.

The radiation absorber of the light-to-heat conversion layer contains at least one of carbon black, metal, infrared ray dye and pigment as a material which absorbs infrared rays to generate heat energy. The radiation absorber of the light-to-heat conversion layer contains an organic binder material which is hardened by ultraviolet rays or heat.

The thermal transfer element further includes an interlayer formed between the light-to-heat conversion layer and the transfer layer, which serves to protect the light-to-heat conversion layer. The transfer layer contains an image forming material to transfer an organic thin film including at least an emission layer.

In another exemplary embodiment of the present invention, a thermal transfer element includes: a base substrate which is a support substrate; a light-to-heat conversion layer formed on the base substrate, converting incident light to heat energy and containing a radiation absorber; and a transfer layer for image formation, wherein the radiation absorber of the light-to-heat conversion layer has a concentration distribution that a concentration is lower as it is closer to the transfer layer, and the transfer layer contains a patterned organic thin-film layer which includes at least an emission layer.

In yet another exemplary embodiment of the present invention, an organic EL (emission layer) display device includes: an organic emission layer including at least an emission layer, which is formed using the thermal transfer element.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a cross-sectional view of a thermal transfer element for forming an organic thin film layer;

FIG. 2 is a graph illustrating a concentration distribution of a radiation absorber contained in a light-to-heat conversion layer of the thermal transfer element;

FIG. 3 is a cross-sectional view of a thermal transfer element according to a first embodiment of the present invention;

FIG. 4 is a cross-sectional view of a thermal transfer element according to a second embodiment of the present invention;

FIGS. 5a to 5c are cross-sectional views illustrating a process of forming an organic thin-film layer of an organic emission layer (EL) display device by using the laser thermal transfer element according to the first embodiment of the present invention; and

FIGS. 6a and 6b are graphs illustrating a concentration distribution of a radiation absorber contained in a light-to-heat conversion layer of a laser thermal transfer element of the present invention.

### DETAILED DESCRIPTION

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the thickness of layers and regions are exaggerated for clarity. Like numbers refer to like elements throughout the specification.

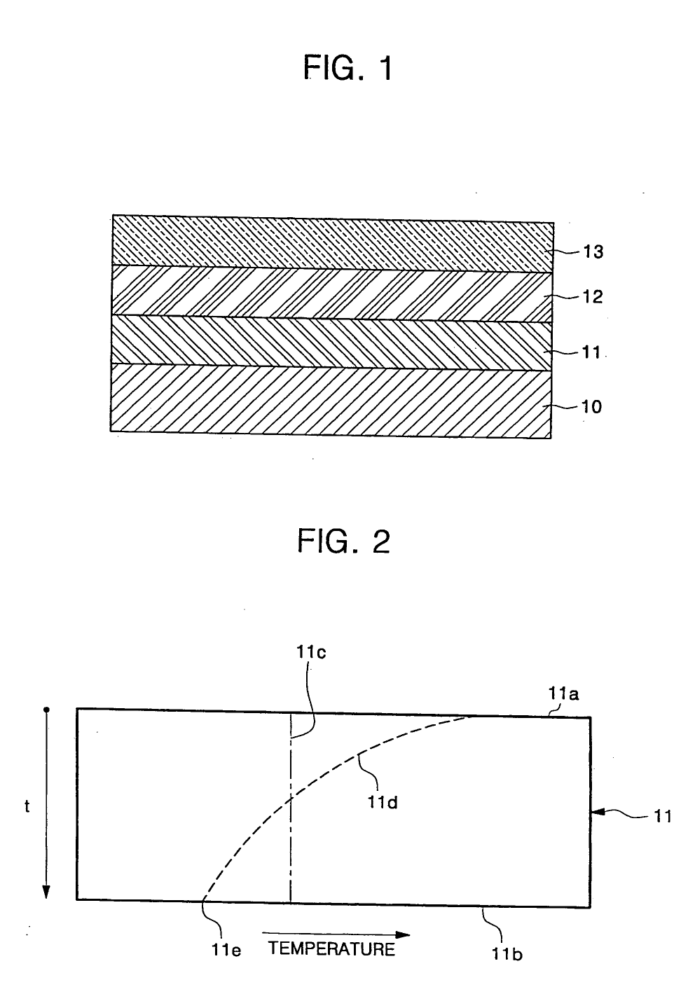

FIG. 1 is a cross-sectional view of a laser thermal transfer element for forming an organic thin film layer.

Referring to FIG. 1, the laser thermal transfer element is composed of a base substrate 10, a light-to-heat conversion layer 11, an interlayer 12, and a transfer layer 13.

A method of forming an organic emission layer using the thermal transfer element is as follows. In the state that a substrate, on which an organic emission layer is to be formed, is closely contacted with the thermal transfer element, laser is irradiated, so that the light-to-heat conversion layer converts the laser light to heat and discharges the heat. As a result, the transfer layer is transferred to the substrate, thereby forming the organic emission layer.

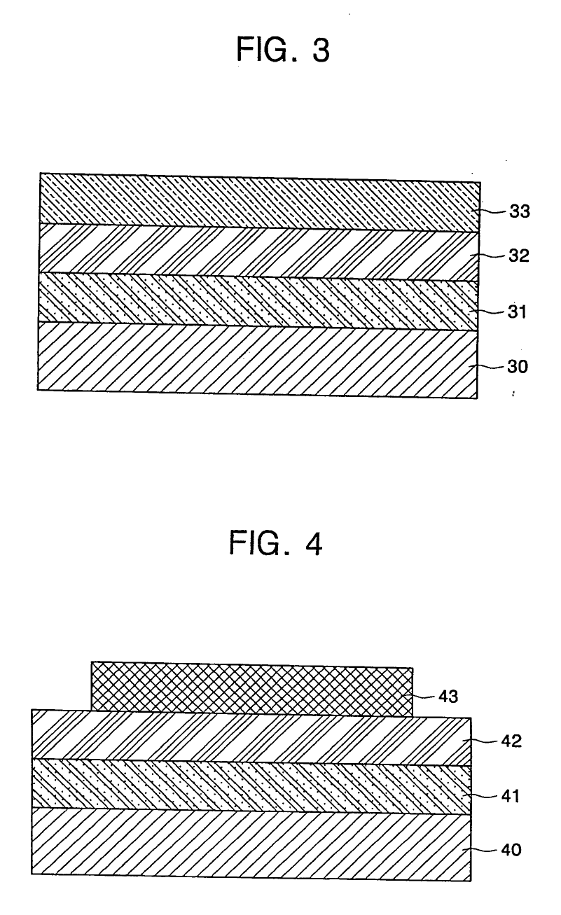

FIG. 2 is a graph illustrating a concentration distribution of a radiation absorber contained in a light-to-heat conversion layer of the thermal transfer element.

Referring to FIG. 2, the light-to-heat conversion layer 11 has a concentration distribution 11c that a radiation absorber is uniformly distributed regardless of a depth “t” thereof. In other words, a concentration of the radiation absorber on a surface 11a contacting the base substrate 10 of the light-to-heat conversion layer 11 and a concentration of the radiation absorber on a surface 11b contacting the interlayer 12 are uniform. As a result, the light-to-heat conversion layer 11 has a temperature distribution, depending on the depth “t,” illustrated by segmented line 11d. That is, a temperature is lower as it is closer to the transfer layer 13.

However, as shown in FIG. 2, when the organic emission layer is formed using the laser thermal transfer element, since the concentration distribution of the radiation absorber in the light-to-heat conversion layer is uniform, defects or characteristic deterioration may occur in the transferred organic emission layer when a heat which is generated in the light-to-heat conversion layer is excessively high while transferring the transfer layer by irradiating the laser.

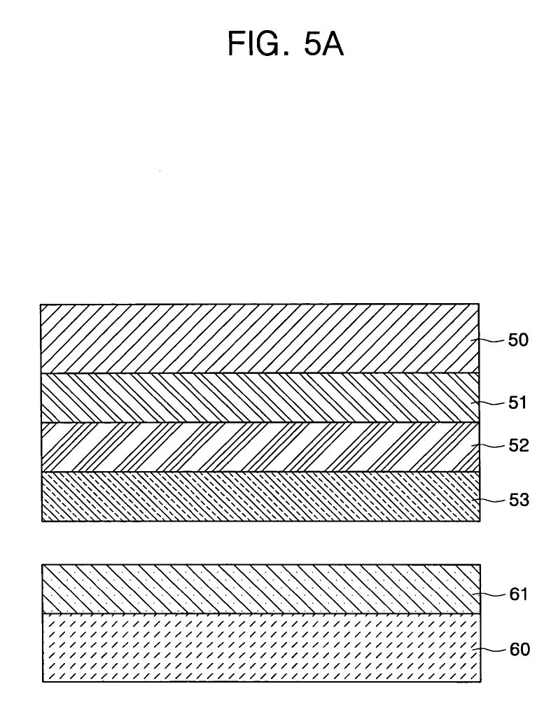

FIG. 3 is a cross-sectional view of a thermal transfer element used to form an organic emission layer of an organic electroluminescent display device according to a first embodiment of the present invention.

Referring to FIG. 3, the thermal transfer element of the present invention includes a base substrate 30, a light-to-heat conversion layer 31, an interlayer 32, and a transfer layer 33. The base substrate 30 serves as a support substrate for supporting the thermal transfer element and is made of a transparent high-molecular material such as Polyethylene Terephthalate (PET). The base substrate can be a glass substrate or film.

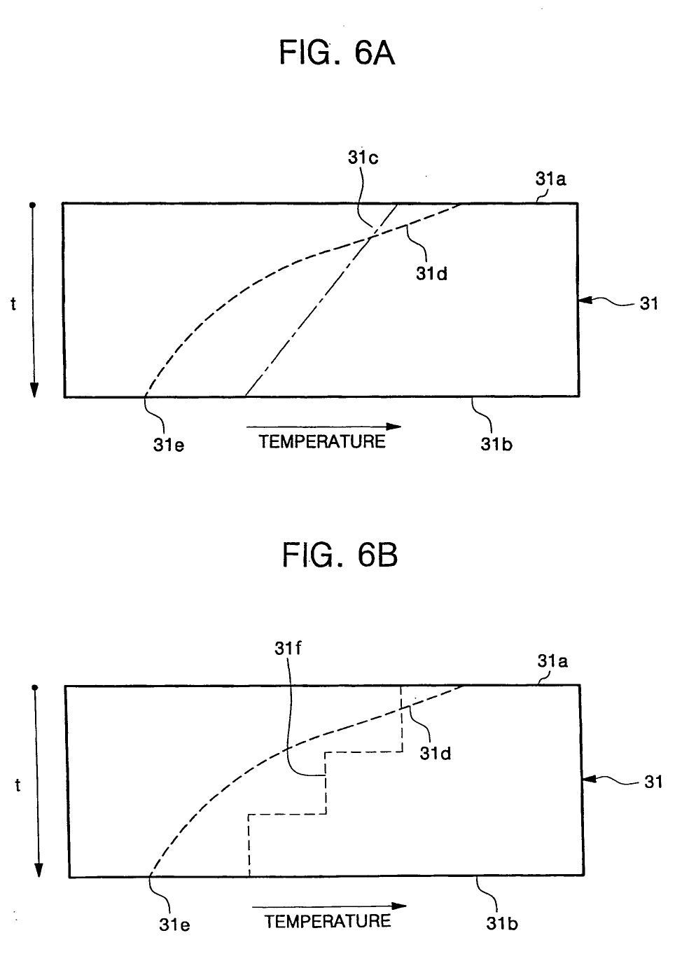

The light-to-heat conversion layer 31 contains a radiation absorber which absorbs laser light and converts it to heat energy. The radiation absorber of the light-to-heat conversion layer 31 has a concentration distribution depending on a depth “t” as shown in FIGS. 6a and 6b. As a radiation absorber for absorbing the laser light, the light-to-heat conversion layer 31 contains a radiation absorber which absorbs the light to generate the heat energy and an organic binder material which is curable by ultraviolet rays or heat. The light-to-heat conversion layer 31 contains infrared ray absorber such as carbon black, carbon, infrared dye, and pigment in addition to aluminum, aluminum oxide and sulfide.

FIGS. 6a and 6b are graphs illustrating a concentration distribution of a radiation absorber contained in a light-to-heat conversion layer of a laser thermal transfer element of the present invention.

Referring to FIG. 6a, the light-to-heat conversion layer 31 has a concentration gradient that a radiation absorber is decreased linearly according to a depth “t” thereof as shown by segmented line 31c. That is, a concentration of the radiation absorber on a surface 31a of the light-to-heat conversion layer 31 contacting the base substrate 30 are relatively higher than that of the radiation absorber on a surface 31b of the light-to-heat conversion layer 31 contacting the interlayer 32, and the radiation absorber has a concentration distribution that a concentration is gradually decreased according to a depth “t” thereof.

Thus, the light-to-heat conversion layer 31 has a temperature distribution that is lower as it is closer to the transfer layer 33 according to a depth “t” like illustrated by segmented line 31d. That is, as it is closer to the surface 31b contacting the transfer layer 33 from the surface 31a contacting the base substrate 30, a concentration of the radiation absorber is gradually decreased.

Therefore, the thermal transfer element of FIG. 1, has a temperature value 11e (FIG. 2) on the surface 11b that the light-to-heat conversion layer 11 contacts the interlayer 12, whereas the thermal transfer element of the present invention (FIG. 3) has a temperature value 31e on the surface that the light-to-heat conversion layer 31 contacts the interlayer 32. As a result, the thermal transfer element of the present invention has a lower temperature distribution at a portion close to the transfer layer 33 compared to the thermal transfer element of FIG. 1 having the uniform concentration distribution of the radiation absorber.

The radiation absorber of the light-to-heat conversion layer 31 of FIG. 6a has a concentration distribution which a concentration is gradually decreased as shown by segmented line 31c, whereas that of FIG. 6b has a concentration distribution which a concentration is stepwise decreased, as shown by segmented line 31f, as it is farther from the base substrate 30 and is closer to the transfer layer 33. Since the radiation absorber of the light-to-heat conversion layer has a concentration distribution which is stepwise decreased as it is closer to the transfer layer 33, a temperature on an interface 31b between the light-to-heat conversion layer 31 and the interlayer 32 is lower than that of the thermal transfer element like that of FIG. 6a.

Referring back to FIG. 3, the interlayer 32 acts to protect the light-to-heat conversion layer and thus has a high heat resistance, and is made of an organic material or an inorganic material. The transfer layer 33 is formed of an image forming material corresponding to a thin film to be formed on the substrate. When an organic thin-film layer is formed using the thermal transfer element according to the first embodiment of the present invention, the transfer layer 33 includes at least one of a hole injecting layer, a hole transporting layer, an emission layer, a hole blocking layer, an electron transporting layer, and an electron injecting layer. The organic thin-film layer is a thin film selected from a high-molecular organic thin-film layer and a low-molecular organic thin-film layer.

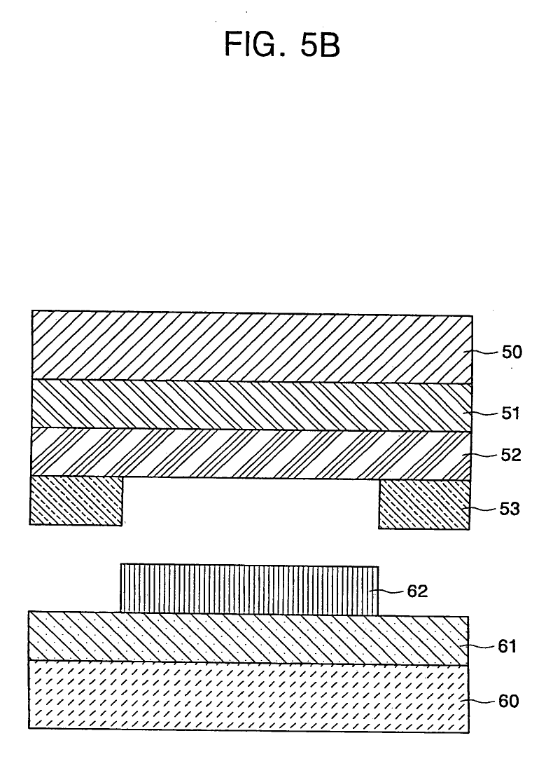

FIG. 4 is a cross-sectional view of a thermal transfer element according to a second embodiment of the present invention.

Referring to FIG. 4, the laser thermal transfer element according to the second embodiment of the present invention includes a base substrate 40, a light-to-heat conversion layer 41, an interlayer, and a transfer layer 43. The base substrate 40 and the interlayer 42 are the same as those of FIG. 3. Like that of FIG. 3, the light-to-heat conversion layer 41 has a radiation absorber that a concentration is gradually or stepwise decreased as it is father from the base substrate 40 or closer to the transfer layer 43 as shown in FIGS. 6a and 6b.

The transfer layer 33 of FIG. 3 is formed over the entire surface of the base substrate 30, whereas the patterned transfer layer 43 is formed as shown in FIG. 4. When an organic thin-film layer is formed using the thermal transfer element according to the second embodiment of the present invention, the patterned transfer layer 43 includes at least one of a hole injecting layer, a hole transporting layer, an emission layer, a hole blocking layer, an electron transporting layer, and an electron injecting layer. The organic thin-film layer is a thin film selected from a high-molecular organic thin-film layer and a low-molecular organic thin-film layer. Thus, the patterned organic thin-film layer is formed on the substrate.

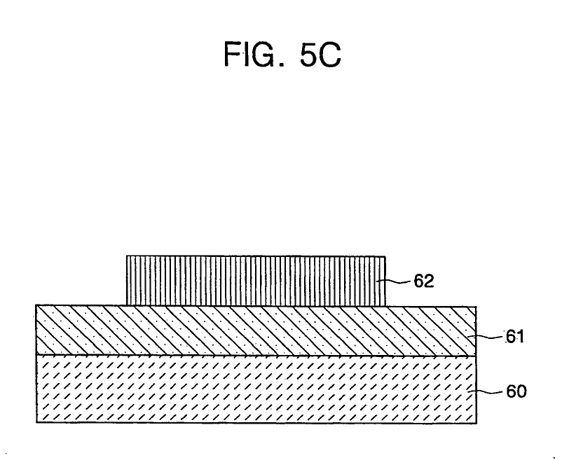

FIGS. 5a to 5c are cross-sectional views illustrating a process of forming an organic thin-film layer of an organic emission layer (EL) display device using a laser thermal transfer element according to a first embodiment of the present invention.

Referring to FIG. 5a, a thermal transfer element having a light-to-heat conversion layer 51, an interlayer 52 and a transfer layer 53 formed on a base substrate 50 is prepared. An insulting substrate 60 having a lower layer 61 formed thereon is prepared. The thermal transfer element is to form the organic thin-film layer of the organic emission layer (EL) display device, and thus the lower layer is a lower electrode, e.g., anode electrode. Then, the insulating substrate 60 is closely contacted with the thermal transfer element.

Referring to FIG. 5b, infrared laser is irradiated to the thermal transfer element closely contacted with the insulating substrate 60, and so the infrared ray absorber contained in the light-to-heat conversion layer 51 absorbs the infrared rays and converts it to heat energy. As a result, the heat energy enables a portion of the transfer layer 53 to be transferred to the insulating substrate 60, whereby an organic thin-film layer 62 is formed on the lower layer 61 as shown in FIG. 5c.

Here, since the radiation absorber of the light-to-heat conversion layer 51 has the concentration distribution of FIGS. 6a and 6b, a temperature on a surface adjacent to the transfer layer 53 used to form the emission layer is relatively lowered, whereby characteristics such as life span and luminous efficiency of the formed emission layer are not degraded, that is, characteristic deterioration of the emission layer does not occur.

Here, what the temperature of the light-to-heat conversion layer is relatively lowered means is that a temperature 31e on a surface 31b of the inventive light-to-heat conversion layer 51 adjacent to the transfer layer 53 is lower than a temperature 11e (FIG. 2) on the surface 11b of the light-to-heat conversion layer 11 adjacent to the transfer layer 13 if it is assumed that the surface 11a of the light-to-heat conversion layer 11 adjacent to the base substrate 10 has the same temperature as the surface 31a of the inventive light-to-heat conversion layer 51 adjacent to the base substrate 50.

A method of forming the organic thin-film layer using the laser thermal transfer element according to the second embodiment of the present invention is the same as that of the first embodiment of the present invention. However, the transfer of the transfer layer and the patterning of the organic thin-film layer are simultaneously performed when the laser thermal transfer element according to the first embodiment of the present invention is used, whereas the transfer of the transfer layer and the patterning of the organic thin-film layer are separately performed when the laser thermal transfer element according to the second embodiment of the present invention is used. Thus, the thermal transfer element according to the second embodiment of the present invention is profitable to form fine pitch and large-size display device.

The embodiments of the present invention are explained such that the light-to-heat conversion layer contains the radiation absorber which absorbs infrared laser light. However, the light-to-heat conversion layer can contain the radiation absorber which absorbs ultraviolet rays and visible rays as well as an infrared ray, and ultraviolet laser and visible laser can be used as a laser source.

The embodiments of the present invention are explained such that a concentration distribution of the light-to-heat conversion layer is lower as it is closer to that transfer layer. This can be applied to the light-to-heat conversion layer of the typical thermal transfer element. Also, the laser thermal transfer element of the present invention is explained to be used to form the organic thin-film layer, but the laser thermal transfer element of the present invention can be used to form other thin-film layers.

Furthermore, the embodiments of the present invention are explained such that a concentration distribution of the light-to-heat conversion layer is varied in the thermal transfer element having the light-to-heat conversion layer, the interlayer and the transfer layer stacked on the base substrate. However, a concentration of the light-to-heat conversion layer can be varied in the thermal transfer element having the light-to-heat conversion layer in the same way as the embodiments of the present invention.

As described above, according to the embodiments of the present invention, characteristics such as life span and luminous efficiency of the transferred organic emission layer may be improved by varying a concentration distribution of the light-to-heat conversion layer of the laser thermal transfer element.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

1. A thermal transfer element comprising:
a base substrate which is a support substrate;
a light-to-heat conversion layer formed on the base substrate, converting incident light to heat energy and containing a radiation absorber; and
a transfer layer for image formation,
wherein the radiation absorber of the light-to-heat conversion layer has a concentration distribution that a concentration of the radiation absorber is lower as the radiation absorber is closer to the transfer layer.

2. The element of claim 1, wherein the radiation absorber of the light-to-heat conversion layer has a concentration distribution that the concentration of the radiation absorber is gradually lower as it is closer to the transfer layer as compared to the concentration of the radiation absorber closer to the base substrate.

3. The element of claim 1, wherein the radiation absorber of the light-to-heat conversion layer has a concentration distribution that the concentration of the radiation absorber is stepwise lower as it is closer to the transfer layer.

4. The element of claim 1, wherein the radiation absorber of the light-to-heat conversion layer has a concentration distribution that the concentration is stepwise lower as it is farther from the base substrate and as it is closer to the transfer layer.

5. The element of claim 1, wherein the radiation absorber of the light-to-heat conversion layer has a concentration distribution that the concentration is gradually lower as it is farther from the base substrate and as it is closer to the transfer layer.

6. The element of claim 1, wherein the radiation absorber of the light-to-heat conversion layer absorbs light generated from one of infrared laser, visible laser and ultraviolet laser.

7. The element of claim 1, wherein the radiation absorber of the light-to-heat conversion layer contains at least one of carbon black, metal, infrared ray dye and pigment as a material which absorbs infrared rays to generate heat energy.

8. The element of claim 7, wherein the radiation absorber of the light-to-heat conversion layer contains an organic binder material which is hardened by ultraviolet rays or heat.

9. The element of claim 1, further comprising an interlayer formed between the light-to-heat conversion layer and the transfer layer, which serves to protect the light-to-heat conversion layer.

10. The element of claim 1, wherein the transfer layer contains an image forming material to transfer an organic thin film including at least an emission layer to form an organic emission layer (EL) display device.

11. A thermal transfer element comprising:
a base substrate which is a support substrate;
a light-to-heat conversion layer formed on the base substrate, converting incident light to heat energy and containing a radiation absorber; and
a patterned transfer layer for image formation,
wherein the radiation absorber of the light-to-heat conversion layer has a concentration distribution that a concentration is lower as it is closer to the patterned transfer layer, and the transfer layer contains an image forming material to transfer a patterned organic thin-film layer which includes at least an emission layer to form an organic emission layer (EL) display device.

12. The element of claim 11, wherein the radiation absorber of the light-to-heat conversion layer has a concentration distribution that the concentration is stepwise lower as it is farther from the base substrate and as it is closer to the transfer layer.

13. The element of claim 11, wherein the radiation absorber of the light-to-heat conversion layer has a concentration distribution that the concentration is gradually lower as it is farther from the base substrate and as it is closer to the transfer layer.

14. The element of claim 11, wherein the radiation absorber of the light-to-heat conversion layer absorbs light generated from one of infrared laser, visible laser and ultraviolet laser.

15. An organic emission layer (EL) display device, comprising:
an organic emission layer including at least an emission layer, which is formed using the thermal transfer element of claim 1.
